(19) United States
(12) Patent Application Publication
(10) Pub. No.: US 2003/0165656 A1
(43) Pub. Date: Sep. 4, 2003

(54) Binder fiber for improved carpet appearance retention and endpoint

(75) Inventors: Richard W. Miller, Pensacola, FL (US); Harold M. Familant, Newport News, VA (US); Tim D. Smith, Cantonment, FL (US); Kenneth R. Thomas, Cantonment, FL (US); Bart S. Campbell, Gulf Breeze, FL (US); Debra N. Hild, Cantonment, FL (US); James E. Polk, Pensacola, FL (US); David B. Horn, Longmeadow, MA (US); Raymond S. Knorr, Pensacola, FL (US); Walter J. Nunning, Pensacola, FL (US); William K. Fairchild, Pensacola, FL (US)

Correspondence Address: Craig M. Lundell, HOWREY SIMON ARNOLD & WHITE, LLP, 750 Bering Drive, Houston, TX, 77057-2198, US

(73) Assignee: Solutia Inc.

(21) Appl. No.: 10/293,227

(22) Filed: Nov. 13, 2002

Related U.S. Application Data
(62) Division of application No. 09/717,166, filed on Nov. 20, 2000.

(51) Int. Cl. B32B 33/00; D05C 17/02; D02J 3/16; D02G 3/04

(52) U.S. Cl. 428/92; 428/97; 428/370; 428/373; 28/239; 57/236; 57/238; 57/239

(57) ABSTRACT

A carpet fiber yarn having carpet fiber and binder material, the yarn being subjected to singeing to remove protruding fiber ends, and subjected to heat sufficient to melt the binder fiber, wherein initial appearance and trafficked appearance of a first test carpet having a pile comprised of the yarn is improved over a corresponding second test carpet having a pile comprised of an unsinged yarn with the carpet fiber and the binder fiber, the unsinged yarn also being subjected to heat sufficient to melt the binder fiber.

### FIELD OF THE INVENTION

The present invention relates to ply-twisted yarns and their use in carpet to improve initial appearance and wear resistance. The present invention also relates to the process of making such yarn and carpet.

### BACKGROUND

Carpet, because of its warmth and pleasing aesthetics, has evolved to become a preferred flooring material in many homes as well as businesses. Manufacturers of carpet or carpet fiber continually search for carpet performance improvements in features such as static charge dissipation, staining, lightfastness and carpet aesthetics. One particular performance area of current interest in the industry is the worn appearance of the carpet pile. As a carpet is subjected over time to traffic, soil and other items in its environment, the tufts (or loops), which make up the pile, tend to bloom, splay, and flatten or entangle, particularly at the very top, which form the pile surface. The identity of the individual tuft tips (or loops), their endpoint definition, is thereby lost producing a worn appearance, which is disliked by consumers. Further, tufts (or loops) tend to mat, or permanently bend or lean, again producing an undesirable worn appearance.

Carpet yarn is typically constructed from either staple fiber or continuous filament yarn. Staple fiber, which refers to cut lengths of fiber from continuous filaments, may be processed into yarn suitable for cut-pile carpets by techniques known in the art. Generally, such techniques involve first combing crimped staple fiber in a carding machine to form sliver, which is a continuous strand of loosely assembled fibers without twist. The sliver is then drafted on a drafting machine to improve its thickness uniformity and subsequently spun and twisted on a spinning machine to form singles twisted yarn. The singles twisted yarn may then be twisted with other singles twisted yarn(s) to form a ply-twisted yarn. Finally, the ply-twisted yarn is subjected to a heatsetting operation where the twist in the yarn is semi-permanently set, thus making the yarn suitable for tufting and further processing into carpet. In a commercial carpet construction, where wearability is even more important than it is for residential constructions, higher levels of twist and more carpet face-weight are commonly used.

The perceived value of carpets is dependent upon several factors including carpet “aesthetics” and carpet “worn appearance”. Carpet “aesthetics” is defined by both the softness and the firmness of the untrafficked carpet pile, as well as the sharpness of the carpet tips, tufts or loops. The term “worn appearance” is used to describe the ability of carpet to retain its initial appearance with respect to tuft (or loop) endpoint and lack of matting after being subjected to repeated traffics, where each “traffic” is the occurrence of an individual walking across the carpet. The term “endpoint” is used to describe the degree of individual tuft distinctness in the initial and the worn carpet. Carpet aesthetics and worn appearance are directly affected by yarn size, yarn twist, and degree and method of heatsetting. However, these variables are directly proportional to the carpet's total production cost. An object of this invention is to produce yarns, which may be tufted into carpets to provide improved carpet aesthetics, worn appearance and production costs.

When carpets are new, they have a pleasing appearance. The yarns, which form the tufts (or loops) provide firmness to the carpet. The ply-twist in the individual tufts (or loops) allows for good tuft definition that gives the carpet a uniform and sharp appearance. Each tuft appears distinctly separate from neighboring tufts. However, when the carpet is subjected to a high degree of traffic, the tufts (or loops) begin to splay, flatten or entangle. The individual filaments of one tuft tend to mingle with filaments of adjacent tufts giving the carpet a matted appearance and producing a loss of its initial appearance.

Numerous solutions have been proposed in the prior art to address the problem of carpet wear resistance or appearance retention. For example, as disclosed in WO88/03969, the entire subject matter of which is incorporated herein by reference, it is known to add heat-activated binder fibers in carpet yarns to improve retention of tuft identify and increase wear resistance. Similarly, U.S. Pat. No. 5,284,009, the entire subject matter of which is incorporated herein by reference, discloses ply-twisted carpet yarn including base fibers and low-melt polyolefin fibers, which melt and bond to each other when the yarn is heatset. It is also known from U.S. Pat. No. 4,871,604, the entire subject matter of which is incorporated herein by reference, to improve carpet wear resistance by applying a binder powder to the pile surface of a carpet and heating the carpet to melt the powder and bond fibers within the yarn that makes up the pile.

Another method involves increasing the number of twists in the ply-twisted yarn. However, increasing the twist decreases yarn bulk and carpet body while substantially increasing carpet production costs.

However, all of these methods suffer from a problem inherent to all staple fiber yarn. That is, staple fiber yarns are fuzzy, i.e., some of the ends of the individual fibers forming the yarn are not merged into the yarn, but rather stick out from the yarn, so that under mechanical action, they can be separated or pulled out from the yarn. Carpets made from such staple-fiber yarns are strongly inclined to produce fuzz which either remains attached to the carpet pile, forming a “beard,” or comes free entirely. This tendency to fuzz/beard has prevented staple fibers from being used in loop carpets—both in the residential and commercial markets. The tendency of staple fiber to fuzz/beard coupled with the poorer worn appearance of cut-pile carpets as compared to loop-pile carpets has also inhibited the growth of staple fiber in the commercial market as a whole.

The result of these problems with staple-fiber carpet yarns is that, despite their economic and dyeability advantages, in recent years the world-wide market share of staple-fiber carpet yarns has been decreasing and shifting toward an increased use of the continuous filament yarns, which represent an alternative to staple-fiber carpet yarns. Continuous filament yarns are not spun from individual, short fibers, but rather are made of individual, continuous synthetic-material fibers extruded from fine dies, the fibers in themselves being compact and several of them being intertwined to form the yarn to be processed.

This shift to continuous filament yarns has occurred even though they suffer disadvantages compared to the staple-fiber yarns, not the least of which is the relative economics of carpet production. While filament yarns, because of their construction, may not have the fuzzing problem associated with staple-fiber yarns, they still cannot be dyed as efficiently. Dyed carpets produced from continuous filament yarns often have an unequal, unlevel, streaky appearance. And, since continuous filament yarns have only limited opportunities to be blended (in the plying operation), physical differences among tuftlines in a carpet (in yarn size or yarn bulk) are easily seen as streaks. Further, continuous filament yarns do not have very good mechanical properties. For example, they exhibit a poorer “retractive force” in response to intermittent loading over time. Mechanical stresses caused by foot prints or pressure points from objects or furniture feet placed on the carpets continue to be visible for a long time after the pressure action has ceased.

These circumstances were the reason for varying efforts over the years to promote staple yarns, the aim of these efforts being to reduce fiber hairiness, and consequently, the accumulation of fuzz. Thus, for example, fiber blends were produced which incorporated other fibers having a lower melting point in a blend with base fibers, to try to enable the fine, projecting, individual, small hairs of the base fiber to be subsequently bonded to the yarn bundle by means of a thermal treatment undertaken in part to induce melting of the low-melt blend component.

Attempts also were made to use different chemical applications, as it were, to glue to the yarn the individual small hairs which are not securely merged into the yarn and which cause the fuzz/beard formation.

Still other attempts were made to reduce staple fiber hairiness. For example, in U.S. Pat. No. 5,903,962, the entire subject matter of which is incorporated herein by reference, a process is utilized in which any protruding hairs of staple fiber yarns are removed by singeing or burning the hairs without negatively affecting the mechanical properties of the yarn.

However, all of these processes still do not provide a carpet having all of the benefits of staple fiber yarn carpet combined with the benefits of continuous filament yarn carpet. Accordingly, there is a need for a carpet that has improved tuft definition, improved worn appearance and wear resistance, reduced fuzzing and bearding, a carpet which can also be manufactured at decreased production costs as compared to carpets of similar quality made conventionally, and a staple carpet that can be made in loop-pile constructions.

### SUMMARY OF THE INVENTION

The present invention relates to carpet yarn having, carpet fiber and binder fiber, the yarn being subjected to singeing to remove protruding fiber ends, and subjected to heat sufficient to melt the binder fiber, wherein the initial appearance, of a first test carpet having a pile including the yarn is improved, as determined by Test A, than with a corresponding second test carpet having a pile including an unsinged yarn with the carpet fiber and said binder fiber, the unsinged yarn being subjected to heat sufficient to melt the binder fiber, or with a corresponding third test carpet having a pile including singed yarn with the carpet fiber and no binder fiber.

The present invention relates to carpet yarn including carpet fiber and binder fiber, the yarn being subjected to singeing to remove protruding fiber ends, and subjected to heat sufficient to melt the binder fiber, wherein the worn appearance of a first test carpet having a pile including said yarn is improved, as determined by Test B, than with a corresponding second test carpet having a pile including an unsinged yarn with the carpet fiber and the binder fiber, the unsinged yarn being subjected to heat sufficient to melt the binder fiber, or with a corresponding third test carpet having a pile including singed yarn with the carpet fiber and no binder fiber.

The present invention also relates to a method for producing a carpet yarn including forming a singles yarn having staple fibers; forming a ply-twisted yarn having at least one of the singles yarn and at least one binder fiber; singeing the ply-twisted yarn to remove protruding fiber ends; and heating the ply-twisted yarn in order to melt said binder fiber, wherein the binder fiber is inserted prior to ply-twisting.

### BRIEF DESCRIPTION OF THE DRAWINGS

FIG. 1 is a ternary diagram of melting point versus composition for a nylon 6, nylon 66 and nylon 12 terpolymer binder material.

FIG. 2 is a ternary diagram of melting point versus composition for a nylon 6, nylon 66 and nylon 69 terpolymer binder material.

### DETAILED DESCRIPTION OF PREFERRED EMBODIMENTS

The carpets of the present invention may be made using, instead of only conventional carpet fibers, a combination of fibers comprising conventional carpet fiber and binder fiber. The term “binder fiber”, as used herein, refers to binder staple fiber or binder monofilament or binder yarn, where the binder fiber may be comprised exclusively of a binder material or a binder material combined with a non-binder material. The term “binder material” refers to a material that will melt or soften during heatsetting and thereby mechanically and/or chemically bond conventional carpet fibers together and the term “non-binder material” refers to a material that will not melt or soften during heatsetting, such as conventional carpet fiber. For example, the binder fiber may be in the form of a yarn comprising conventional staple fiber and binder fiber, or the binder fiber may comprise a binder-non-binder material bicomponent fiber, such as a binder material sheath over a non-binder material core, or a non-binder material yarn coated with a binder material. The term “yarn” refers to a staple fiber yarn (either a singles or a ply-twisted yarn) or a bulked continuous filament (BCF) yarn (either singles or cabled yarn). The present invention relates preferably to ply-twisted yarns, comprising carpet yarn comprising a conventional staple fiber yarn ply-twisted with binder fiber in the form of multifilament yarn, that have been singed to remove free ends. The carpet made from these plied-yarn blends comprises a primary backing and twisted evenly sheared, heatset pile yarn in the form of individual lengths of plied yarn (tufts), each of which projects upwardly from the backing and terminates as a cut end (cut pile) or uncut end (loop).

Carpet fibers that may be utilized in making the fiber blends of the present invention are typically crimped fibers having deniers of at least 1 denier per filament (dpf) and a crimp frequency of greater than 1 crimps-per-inch, and more preferably between 5 and 16 crimps-per-inch. (The term “carpet fibers”, as used herein, refers to conventional carpet fibers (staple or continuous filament) described in this paragraph and the term “carpet yarn”, as used herein, refers to yarns made from said carpet fibers). Preferably, the carpet fibers have deniers of at least 8, usually between 12 and 25, and a non-round cross-section (e.g., trilobal cross-section). Preferred carpet fibers are polyamides, particularly nylon 6 and nylon 66, polyesters, particularly poly(ethylene terephthalate), olefins, particularly polypropylene, acrylics, and combinations thereof. Other suitable carpet fibers include other nylons and polyester fibers, such as nylon 6/12 fibers or polybutylene terephthalate fibers. The carpet fibers can also include additives such as light stabilizers, flame retardants, dyes, pigments, optical brighteners, antistatic agents, surfactants and soil release agents.

The binder material useful in making the carpet yarn of the present invention typically has a melting point range of 90-190° C., preferably 95-160° C., more preferably 100-140° C., under ambient humidity conditions, where the melting point is considered to be the melting peak in a DSC (Differential Scanning Calorimeter) scan (scan rate of approximately 20° C./minute). The binder material must also be capable of wetting and spreading on the carpet fiber in order to provide adequate adhesion during any subsequent dyeing steps and final use. In the binder material, it may be advantageous to utilize additives to reduce melt viscosity, enhance wetting properties or modify melting temperature. In addition, special spin finishes may be utilized which impart necessary antistatic and lubricating properties to the binder material for efficient mill processing. Preferably, the binder material is economic, compatible with the conventional carpet fibers so as to enable it to adhere thereto, and capable of being activated, i.e., melted or sufficiently softened at the temperatures normally found in conventional heatsetting apparati such as a Superba® or Suessen® heatsetting unit, available from American Superba, Inc. and American Suessen Corp., respectively.

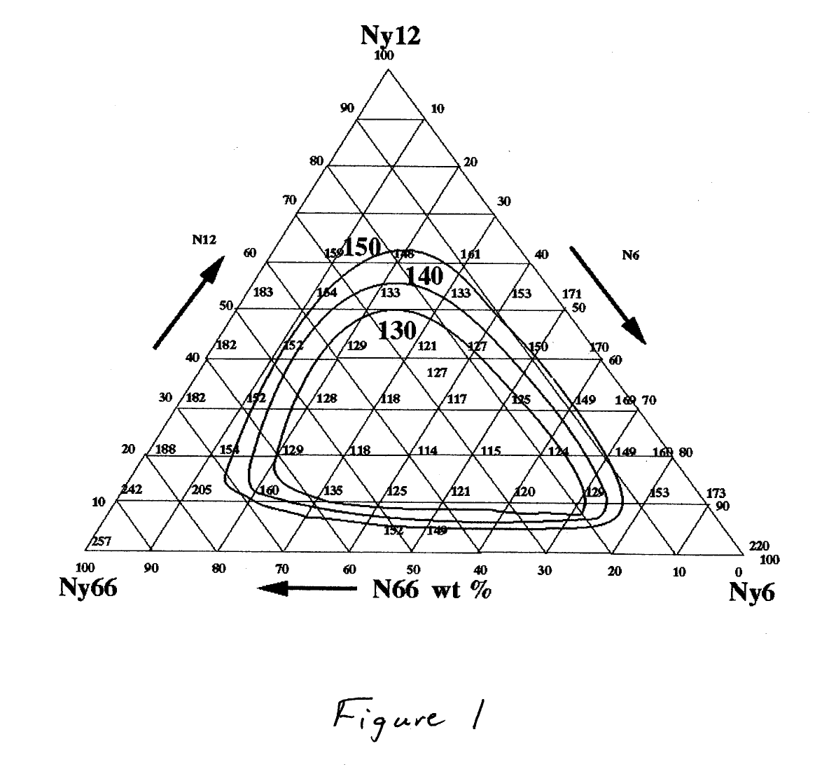

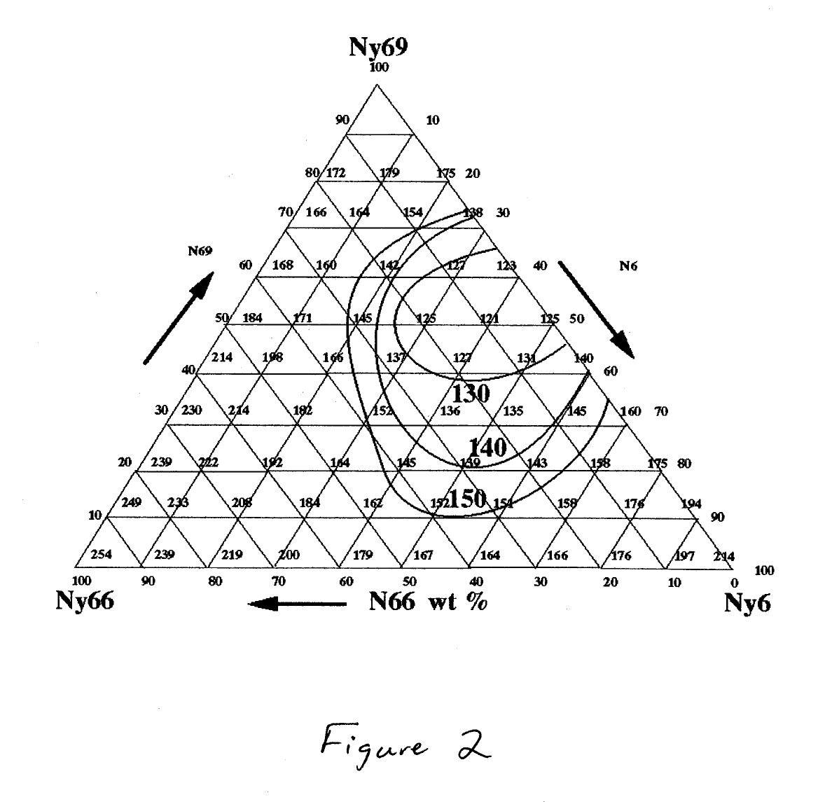

The binder material may be comprised of any polymer, including any polymers having one or more components (i.e., copolymers, terpolymers, etc.), provided that they possess the binder characteristics defined herein. The binder material may be utilized in various forms including fibers, yarns, powders, liquids, or any form suitable for use on or in carpet fiber. The preferred binder material is made from low cost components, such as nylon 6, nylon 66 and nylon 12. One example of such a binder material for polyamide carpet fibers is a fiber melt spun from a copolyamide comprised of nylon 6, nylon 66 and nylon 12 (referred to herein as 6/66/12, e.g., Griltex 1G, available from EMS-Chemie, Inc.), plus a chain terminator to control molecular weight. The ternary diagram of FIG. 1 depicts amounts of each component in the binder material, including those compositions falling within the 150° C. contour, preferably within the 140° C. contour, and more preferably within the 130° C. contour. Preferably, the nylon 6/66/12 may be derived from about 30 to about 40 wt % caprolactam, about 20 to about 40 wt % hexamethylene diamine adipate and about 25 to about 45 wt % lauryl lactam by weight of the copolymer. Another example of a low cost binder material is the polyamide fiber spun from copolymers of nylon 6 and nylon 69 or terpolymers of nylon 6, nylon 66 and nylon 69. Of particular value is the 6/69 copolymer comprised of about 25 to about 65 wt % nylon 6 (referred to herein as 6/69). Copolymers in this composition range have melting points of approximately 125-150° C. and are readily melt spun. More preferred nylon 6/69 copolymers possess melting points of about 125° C. to about 130° C. and are composed of about 35 to about 55 wt % nylon 6. Terpolymers generally give better adhesion, but are often more difficult to melt spin. Preferred compositions for the terpolymer comprised of nylon 6, nylon 66 and nylon 69 may be defined by the ternary contour plot of melting point versus composition as shown in FIG. 2, with compositions falling within the 150° C. contour, preferably within the 140° C. contour, and more preferably within the 130° C. contour. Examples of suitable 6/66/69 compositions include 40/20/40 (wt %) (Tm =130° C.); 25/20/55 (wt %) (Tm=130° C.) and 40/10/50 (wt %) (Tm=121° C.), available from Shakespeare Specialty Polymers. Other components or precursors for making the copolyamide may be substituted for or used in addition to any of the three components listed above, as needed to achieve the desired binder fiber properties. Examples of other suitable components include lactams, amino acids or salts of diacids and diamines. Examples of diacids, which may be used along with a diamine, such as hexamethylene diamine, are isophthalic acid, undecanoic acid, docecanoic acid, azelaic acid and sebacic acid. Examples of diamines, which may be used along with a diacid, such as adipic acid are ethylene diamine, hexamethylene diamine and nonamethylenediamine. The preferred components are those which are readily available commercially and form linear crystallizable copolyamides, which may be melt spun on conventional spinning machines.

Binder materials, other than polyamides, may be used for nylon carpet fibers, provided the conditions of melting, wetting and spreading are satisfied. An example of a particularly useful material is the unbranched or lightly branched copolymer of 85% polyethylene and 15% ethylene oxide (referred to herein as “modified PE”). When melt spun into fibers with adequate tenacity (normally 2 grams/denier or more) these fibers can be inserted into nylon carpet yarns with excellent adhesion after heatsetting.

The binder material suitable for use with polyester, polyolefin or acrylic fibers depends upon matching the binder material with the physical and chemical properties of the intended base carpet fiber and processing conditions typically used for that type of carpet fiber. For example, a functionalized polyethylene or EVA-type (ethylene vinyl acetate) binder material (e.g., Plexar® PX 5327, available from Equistar Chemicals, LP) may be selected for use in polypropylene carpet fibers. The preferred embodiment is a melt spun fiber. However, in cases where spinnability is difficult, as is the case for EVA's, other options, such as binder coated fibers or bicomponent fibers may be used.

By selection of various component, their amounts, and synthesis of the thermally activated, binder material, it is possible to modify end-use properties of the finished carpet to improve carpet aesthetics, particularly tuft (or loop) definition, worn appearance retention, resilience, and fuzz/bearding. The thermal shrinkage, tenacity, modulus, elongation to break, melt viscosity, softening point, and melting point of the binder material contribute to achieving ideal properties in the final product. Moreover, various properties of the carpet fiber, including denier-per-filament, cut length, fiber cross-section, crimp type and frequency, surface finish, melt viscosity, and dye affinity, among others, also affect the properties of the resulting carpet.

The conventional carpet manufacturing process for staple carpet fiber takes randomly oriented carpet fibers and subjects them to a series of carding and pinning operations to blend and orient the individual carpet fibers in a common direction. The final drafting stage, spinning, imparts twist to form a continuous, singles yarn comprised of many short fibers twisted together—commonly 40-150 fibers would be found in any cross-section. In the present invention, binder fiber may be blended as staple fiber with the conventional carpet staple fibers in the early stages of carding or inserted as a continuous binder fiber yarn after the final drafting into the spun singles package.

Two or more conventional carpet singles yarns may then be twisted together using a variety of plytwisting processes: e.g., ring twisting, 2-for-1 twisting, or open-ended twisting. The present invention relates preferably to inserting the binder fiber as a yarn prior to plytwisting. This may be accomplished employing a variety of different techniques, and the binder fiber is preferably positioned between at least two singles yarns. The binder fiber may be inserted during a doubling process, also referred to as a parallel winding, whereby the binder fiber is joined with two other singles yarns and subsequently wound onto a package that is 2-for-1 twisted. Another method is to join the binder fiber with a singles yarn and wind onto a package via a Murata® (available from Murata Machinery, LTD), Schlafhorst® (available from W. Schlafhorst and Co.) or other auto winder device. The binder fiber/singles package is then placed into a 2-for-1 twister along with a second singles package containing no binder fiber. Still another process involves inserting the binder fiber directly into a ring twister from a creel containing two singles yarns and a binder fiber bobbin. A technique also exists which allows for direct insertion of the binder fiber into the Murata®, Schlafhorst® or other auto winder device such that the package formed is available for 2-for-1 twisting with a second package containing no binder fiber insert. Preferably, the plytwisted yarns are then passed through a singeing operation to reduce the number of free fiber ends, and then through a conventional heatsetting unit such as a Superba® or Suessen® to set the imparted twist and in the present invention to melt or soften the binder fiber. Typically, Superba® heatsetting subjects the nylon 66 yarn to temperatures of 132-138° C. in a pressurized steam environment and Suessen® heatsetting subjects the nylon 66 yarn to temperatures of 195-200° C. in a superheated steam environment. The heatset yarns may then be tufted into carpet and dyed conventionally to produce cut-pile saxony, cut-pile textured, loop, and combination loop and cut-pile carpets.

One of the features of this invention lies in the combined use of a ply-twisted yarn, comprising a binder fiber and a conventional carpet staple yarn, with subsequent singeing of the ply-twisted yarn. This combination provides a staple-fiber carpet yarn having appearance and wear resistance properties that are unexpectedly improved over (1) an unsinged staple-fiber carpet yarn comprising a binder fiber and a conventional staple fiber yarn or, (2) a singed staple-fiber carpet yarn comprising solely conventional fiber yarn without binder fiber.

With regard to wearability of a carpet, the combination of singeing carpet yarn with use of binder material in the carpet yarn would not have been expected by one of ordinary skill in the art to have provided any improvement over a carpet constructed from carpet yarn that includes binder material that has been heatset but not singed. Even though the use of binder material in carpet yarn provides improved wearability by bonding the individual fibers together in the yarn, the artisan would not have expected singeing to have provided any enhanced wearability, since singeing is utilized to remove loose fiber ends protruding from the yarn, not improve tuft integrity. Accordingly, the artisan would have expected that a carpet composed of singed yarn with binder material would have provided equivalent wearability to a carpet composed of unsinged yarn with binder material, and not a significant improvement in wearability as was discovered with the present invention.

With regard to initial appearance of a carpet, the combination of singeing carpet yarn with use of binder material in the carpet yarn would not have been expected by the artisan to have provided any significant improvement over a carpet constructed from carpet yarn that included binder material but is not singed. Because the binder material serves to tack plies together within the carpet tuft, it might be expected by the artisan to provide the majority of improvement in carpet aesthetics and the two treatments to produce equivalent carpets. Since singeing removes loose fiber ends protruding from the yarn, some improvement in initial aesthetics might have been expected from a carpet made from singed yarns, but that same slight improvement in initial aesthetics may have been expected from the use of binder material in carpet (due to the bonding of loose ends to the yarn). Since both techniques provide redundant treatment (i.e., elimination of loose fibers ends from the yarn), the combination of singeing and the utilization of binder material would not have been expected by the artisan to have provided the carpet with additive improvement in initial appearance, but merely minimal improvement. Thus, one of ordinary skill in the art would not have expected that the use of singeing and binder material in carpet yarn would have provided significant improvement in initial appearance of the resulting carpet, as was discovered with the present invention. Important in this regard is the slight melting taking place by a portion of the binder fiber that occurs while the yarn is being singed under a slight tension in contrast to the majority of the binder fiber melting free of tension in the heatsetting operation.

Additionally, this combination of the present invention allows loop carpet constructions, the preferred domain of carpets made from bulked continuous filament (BCF), to be produced for staple yarns whereby either singular treatment would result in unfavorable initial carpet aesthetics and/or wearability Further, the combination might allow high density, commercial carpets to be manufactured with less twist and less fiber face weight, both economic advantages.

In this process according to the present invention, singeing may be performed using a Kuester® (available from Kuesters Zittauer Maschinenfabric GmbH) yarn singeing unit. Such singeing process may be conducted as described in U.S. Pat. No. 5,903,962, the entire subject matter of which is incorporated herein by reference. Other methods for singeing may include various short term, high temperature treatment, such as by means of a laser. Preferably, the singeing process is conducted prior to heatsetting. With the utilization of this invention, heatsetting conditions normally used are sufficient to activate the binder fiber/material to create bind points, either chemical and/or mechanical bonds, which strengthen the final product, thereby imparting other characteristics which are desirable. In other words, standard heat conditions for heatsetting yarn, such as in the Suessen® or Superba® processes, will cause at least one component in the binder fiber/material to melt sufficiently so that it loses its structural identity as a fiber/yarn and is capable of flowing. The molten component from the binder fiber/material will flow to intersecting points of the conventional carpet fibers and upon subsequent cooling will encapsulate and bond intersecting points of the conventional carpet fibers. In the heatsetting process, motion of the fiber while in the relaxed state, caused by vibration or air currents or capillary action, sufficiently induces the molten binder material to flow to the intersecting “touch points” of the conventional carpet fiber, as a function of the melt flow properties of the binder material and surface characteristics of the conventional carpet yarn plys. As the plied yarn(s) emerges from the elevated temperature condition of heatset, the binder material solidifies and encapsulates or bonds two or more conventional carpet fibers together at intersecting points in a durable bond.

Subsequent processing including dyeing, finishing, and back coating using commercial processing methods does not soften the bond points sufficiently to weaken them. The heatset yarn of the invention provides important property improvements, e.g., improved carpet aesthetics, particularly endpoint definition, in the untrafficked carpets and trafficked carpets, and improved wearability in the trafficked carpets, in the production of both cut-pile and loop-pile carpets.

In one embodiment of the present invention, the binder fiber can be cut into staple and blended with base staple fiber and the resulting staple fiber blend can then be processed as set forth herein. It is important to insure a thorough blending to avoid potential clumps in the finished carpet. The staple fiber blend should contain 1-25 weight percent binder fiber, preferably 1-15 weight percent, and more preferably 1-5 weight percent. This blend combination may be subsequently singed, heatset, and processed into carpets.

In another embodiment of the present invention, a BCF, used as a conventional carpet yarn, may be commingled with binder fiber in the form of a yarn before ply-twisting. The binder yarn may be inserted into either one or both of the textured yarn ends that are twisted together in the subsequent cabling operation. The cabled yarn may then be singed by the Kuester® unit, heatset, usually by the Superba® process, and finally tufted into loop or cut-pile carpets. While we recognize that BCF yarn has no free ends to singe off, the partial melting of the binder material under tension during the singeing treatment leads to the improved carpet performance.

In a further embodiment of the present invention, the binder fiber, in the form of a yarn, may be inserted into a base staple yarn prior to ply-twisting. Ply twisting can be performed using ring twisting, 2-for-1 twisting, or open-ended twisting. The binder yarn is inserted in an amount of about 1 to about 25%, preferably about 1 to about 15%, and more preferably about 1 to about 5% by weight of the carpet yarn. This combination is subsequently singed and heatset using the Kuester® yarn singeing unit and the Suessen® or Superba® heatsetting units, then processed into carpet as described herein.

This invention may also allow increased production rates of the carpet yarn through the heatsetting process. Commercially and most typically, the dwell time of nylon 66 carpet yarn in the Suessen® is 60 seconds. Such a dwell time is necessary to achieve both adequate appearance retention and uniform dyeing of the carpet yarn. This invention allows the dwell time through the Suessen® to be decreased from 60 to 50 seconds or less, thus increasing the production rate by at least 16% with no reduction in appearance retention and no adverse effects on dyeing of the resulting carpet yarn. It is believed that slight melting of a portion of the binder fiber occurs while the yarn is being singed, and thus, decreases the amount of binder fiber melting at heatsetting required to provide comparable appearance retention of the resulting carpet.

The carpets and carpet yarns of the present invention are further defined by the following Examples.

### EXAMPLES

The following tests are utilized in measuring the carpet aesthetics and wearability of the Examples:

I. Untrafficked Carpet Aesthetics: the following test (Test A) given in this section provides a means by which a blend of carpet fibers and binder fiber that have been singed, heatset and converted into carpets be compared to other carpets with respect to their ability to impart aesthetics improvement to untrafficked cut-pile and loop- pile carpets.

Cut-pile, saxony test carpets are made as follows:

(1) The carpet fibers are converted to provide 3.75 cotton count (cc) singles yarn having 5.6 tpi of twist in the Z-direction. One of these singles yarns is inserted with the binder yarn in a parallel winding operation through a Murata® winder. One inserted-singles yarn and one non-inserted-singles yarn are then twisted together on a 2-for-1 ply twister (e.g., Volkman® Vis-05-C available through American Volkman Corporation) with 5.1 tpi of twist in the S-direction to provide the Inserted/Singed Test yarn. A second test yarn (Singed Only Control 1 Test yarn) is made in exactly the same manner except in this instance the inserted singles yarn is replaced with a uninserted singles yarn in the ply-twist operation.

(2) the Inserted/Singed Test and Singed Only Control 1 Test yarns are singed in a Kusters® Yarn Singe Production Unit (burner pressure set at 10 mbar pressure), while a third blend test yarn (Inserted Only Control 2 yarn) is not singed.

(3) the Inserted/Singed Test, Singed Only Control 1, and Inserted Only Control 2 Test yarns are heatset under conditions that are suitable for the carpet fibers of the yarn.

(4) Three cut-pile carpet samples of saxony construction (test carpets) are made. One of the test carpets (Singed Only Control 1) is made using the Singed Only Control 1 Test yarn; one of the test carpets (Inserted Only Control 2) is made using the Inserted Only Control 2 Test yarn; and one test carpet (Inserted/Singed Test) is made using the Inserted/Singed Test yarn. All three test carpets are made using the following construction:

(a) gauge (spacing between rows of tufts)—1/10 ga.

(b) tuft height—5/16 inches.

(c) face weight—42 ounces of yarn per square yard of carpet with the spacings between stitches being selected to provide the 42 ounce face weight.

(d) backing—the primary backing is a polypropylene backing, such as Polybac® (available from Amoco Fabrics and Fibers) backing (style 2477) and the secondary backing is also a polypropylene backing, such as Actionbac® (also available from Amoco Fabrics and Fibers) backing (style 3801).

(e) The test carpets are dyed using conventional beck dyeing (i.e., batch dyeing a continuous loop of carpet in relaxed form using a tank and a reel to advance the carpet) equipment under conditions that are suitable for the carpet fibers of the yarn.

(f) Test A(“Triangle Test” described in M. Meilgaard, G. V. Civille, and B. T. Carr, Sensory Evaluation Techniques,3^{rd} Edition (1999) by CRC Press, pages 61-68—Two, 11 inches by 17 inches untrafficked carpet samples (long direction in the tuftline direction) are cut from each of the three test carpet samples {Inserted/Singed Test (A1 and A2), Singed Only Control 1(B1 and B2), and Inserted Only Control 2 (C1 and C2)}. Each of the following eight sample groupings are randomly ordered then presented to a grader knowledgeable in the field of carpet testing (i.e., testers with at least five years experience testing carpets) who visually compares and segregates each triad into subgroups of two and one in a side-by-side comparison without knowledge of which test carpet is which and the subgrouping (either the one or the two) having the better initial carpet aesthetics is identified:

group 1: A1 A2 B1

group 2: A1 A2 B2

group 3: A1 B1 B2

group 4: A2 B1 B2.

group 5: A1 A2 C1

group 6: A1 A2 C2

group 7: A1 C1 C2

group 8: A2 C1 C2.

Groups 1 to 8 are evaluated four (4) times by one grader knowledgeable in the area of carpet testing, two (2) times each by two graders knowledgeable in the area of carpet testing, or one (1) time each by four graders knowledgeable in the area of carpet testing—in total, groups 1 to 4 are evaluated 16 times to assess the significance of the difference between the Inserted/Singed Test carpet and Singed Only Control 1 Test carpet and groups 5 to 8 are evaluated 16 times to assess the significance of the difference between the Inserted/Singed Test carpet and Inserted Only Control 2 Test carpet. Nine correct segregations in either of the 16 assessments testing groups 1 to 4 or 5 to 8 is significant at the 95% level of confidence; 11 correct segregations at the 99% level of confidence; 12 correct segregations at the 99.9% level of confidence. (Table T8 in M. Meilgaard, G. V. Civille, and B. T. Carr, Sensory Evaluation Techniques, 3^{rd} Edition (1999) by CRC Press, page 369).

II. Trafficked Carpet Appearance: the following tests (Test B and Test C) given in this section provide a means by which a blend of carpet fibers and binder fibers that have been singed, heatset and converted into carpets may be compared to other carpets with respect to their ability to impart improved worn (or trafficked) appearance and appearance retention characteristics to cut-pile and loop-pile carpets.

Untrafficked test carpets (Inserted/Singed Test, Singed Only Control 1 and Inserted Only Control 2) are made as described above. Two (2) samples of each test carpet (Inserted/Singed Test, Singed Only Control 1, and Inserted Only Control 2) are subjected to 40,000 traffics using the procedure described in ASTM Designation D2401. The carpet samples (9 inches by 22 inches—the short dimension is the tuftline direction) are placed directly on the floor—a pad is not used—and the directional flow of traffic is in the short dimension; two replicate samples are worn for each of the test carpet samples.

(f) Test B—Test B(Triangle Test)—Two, 9 inches by 22 inches carpet samples are cut from each of the three test carpet samples {Inserted/Singed Test (A1 and A2), Singed Only Control 1 (B 1 and B2), and Inserted Only Control 2 (C1 and C2)} and trafficked. Each of the following eight sample groupings are randomly ordered then presented to a grader who visually compares and segregates each triad into subgroups of two and one in a side-by-side comparison without knowledge of which test carpet is which and the subgrouping (either the one or the two) having the less worn appearance is identified:

group 1: A1 A2 B1

group 2: A1 A2 B2

group 3: A1 B1 B2

group 4: A2 B1 B2.

group 5: A1 A2 C1

group 6: A1 A2 C2

group 7: A1 C1 C2

group 8: A2 C1 C2.

Groups 1 to 8 are evaluated four (4) times by one grader knowledgeable in the area of carpet testing, two (2) times each by two graders knowledgeable in the area of carpet testing, or one (1) time each by four graders knowledgeable in the area of carpet testing—in total, groups 1 to 4 are evaluated 16 times to assess the significance of the difference between the Inserted/Singed Test carpet and Singed Only Control 1 Test carpet and groups 5 to 8 are evaluated 16 times to assess the significance of the difference between the Inserted/Singed Test carpet and Inserted Only Control 2 test carpet. Nine correct segregations in either of the 16 assessments testing groups 1 to 4 or 5 to 8 is significant at the 95% level of confidence; 11 correct segregations at the 99% level of confidence; 12 correct segregations at the 99.9% level of confidence. (Table T8 in M. Meilgaard, G. V. Civille, and B. T. Carr, Sensory Evaluation Techniques, 3^{rd} Edition (1999) by CRC Press, page 369).

The statistic for this type of analysis follows from the properties of a binomial distribution. The following is a calculation of the probability that two inconsistent assignments of the 16 could occur by chance alone:

Chance Probability=(16!/(14!·2!))·(⅓)¹⁴(⅔)²(2 of 16 incorrect) 120·(¼,782,969)(4/9)=0.000011151 ˜1 in 89,681 clearly a rare event!

TABLE I
Probabilities in Triangle Test

| No. of Correct Assignments | |
|---|---|
| For Every Sixteen Assessed | Chance Probabilities |
| 16/16 | 0.000000023˜1/43,046,721 |
| 15/16 | 0.000000743˜1/1,345,210 |
| 14/16 | 0.000011151˜1/89,681 |
| 13/16 | 0.000104073˜1/9,609 |
| 12/16 | 0.000676474˜1/1,478 |
| 11/16 | 0.003247077˜1/308 |
| 10/16 | 0.011905947˜1/84 |
| 9/16 | 0.034016993˜1/29 |
| 8/16 | 0.076538234˜1/13 |

When two incorrect assignments are made, one can say that the results are significant at the 0.999988849 level of significance, i.e., there is 1 chance in 89,681 that this degree of agreement could occur by chance alone. The chance of this degree of consistency being due to random chance is rare indeed: even 9 consistent segregations of 16 times tried means the grader is consistently seeing differences at greater than the 0.96 level of confidence. Table I lists the chance probabilities for 16 of 16 to 8 of 16 correct assignments.

The trafficked test carpet samples (Inserted/Singed Test, Singed Only Control 1, and Inserted Only Control 2) are visually compared and the carpet having the better appearance with respect to carpet aesthetics (particularly tuft endpoint definition) and lack of matting is identified. (Color appearance is not taken into consideration.) Test B given in this paragraph provides a simple means for determining which of two carpet types has better worn appearance characteristics.

(a) Test C—appearance loss between each of the untrafficked and trafficked carpets is determined by evaluating the appearance retention of both test carpets using a single grader knowledgeable in the area of carpet testing and reference photographs in the manner described in ASTM D2401. The grader determines an ASTM grade for the both replicated samples from each of the three test carpets and averages the grades: the lower the averaged grade, the lower the perceived change in the test carpet's appearance after trafficking. Test C given in this paragraph provides a means for quantitatively assessing the differences in appearance retention characteristics between two or more carpets. It is particularly useful for evaluating change for carpets exhibiting comparable initial appearances. In most of the examples that follow, Test B, a relative comparison of general surface wear, is more useful since the initial appearances for the Test and Control carpets are quite different, making comparisons as to the degree of change with wear difficult.

### EXAMPLE I

This example illustrates the preparation of carpet fiber/binder fiber blends of the invention and the improved worn surface appearance and initial carpet aesthetics characteristics of loop carpet made therefrom. Specifically, the benefits of combining singeing with binder fiber are demonstrated relative to those derived from inserting the binder fiber alone. Test carpets are made using conventionally crimped nylon 66 carpet staple fibers which are uniform in appearance and have a length of 7½ inches, a denier of 15, and an average of 10.5 crimps per inch. These fibers are carded and spun into singles yarn; the singles yarn inserted with a 75 denier/12 filament binder fiber (6/66/12) at parallel winding through the Marata® (at speeds of 1200 mpm); then a singles without the binder fiber and a singles with the binder fiber are plied together in a 2-for-1 twisting operation. This plied yarn is made at a 2.25/2 cotton count (cc) and twisted at 4.2Z (singles)×3.5S(ply). One test yarn includes binder fiber (Inserted/Singed Test yarn) is singed (Kuesters® ), heatset (Suessen® at 200° C.), tufted into a loop carpet construction (32 oz face weight, 5/16″ pile height, ⅛ gauge), then continuous fluid dyed to a beige shade. A second includes binder fiber (Inserted Only Control 2 yarn) is not singed, heatset (Suessen at 200° C), tufted into a loop carpet construction (32 oz face weight, 5/16″ pile height, ⅛ gauge), and then continuous fluid dyed to a beige shade.

These two carpets are evaluated for carpet aesthetics as described in Test A, then subjected to 100,000 traffics (graded in 20,000 traffic increments) and evaluated for worn surface appearance as described in Test B. Table II presents results from Test A and B. The pair of carpets untrafficked and worn to various levels of traffics are compared by Test A to determine how significant the level of difference in untrafficked carpet aesthetics and by Test B to determine how significant the level of difference in carpet wear trafficked to each of these levels. In each instance, the Inserted/Singed Test Carpet is selected as having significantly better unworn carpet aesthetics and better worn carpet appearance.

TABLE II
Inserted/Singed (A1 & A2) versus Inserted Only
Control 2 (C1 & C2)

| | Untrafficked | 20K | 40K | 80K | 100K |
|---|---|---|---|---|---|
| Test A (Untrafficked) | 15/16 | n/a | n/a | n/a | n/a |
| Test B (Trafficked) | n/a | 14/16 | 16/16 | 15/16 | 15/16 |

### EXAMPLE 2

This example illustrates the preparation of carpet fiber/binder fiber blends of the invention and the improved worn surface appearance and initial carpet aesthetics characteristics of loop carpet made therefrom. Specifically, the benefits of combining singeing with binder fiber are demonstrated relative to those derived from singeing alone and those derived from insertion of the binder fiber alone. Test carpets are made using conventionally crimped nylon 66 carpet staple fibers which are uniform in appearance and have a length of 7½ inches, a denier of 15, and an average of 10.5 crimps per inch. These fibers are carded and spun into singles yarn; the singles yarn inserted with a 75 denier/12 filament binder fiber (6/66/12) at parallel winding through the Murata® (at speeds of 1200 mpm); then a singles without the binder fiber and a singles with the binder fiber are plied together in a 2-for-1 twisting operation. This plied yarn is made at a 2.25/2 cotton count (cc) and twisted at 4.2Z (singles)×3.6S (ply). One test yarn (Inserted/Singed Test yarn) item is singed (Kuesters®), heatset (Suessen(® at 200 C.), tufted into a loop carpet construction (32 oz face weight, 5/16″ pile height, ⅛ gauge), then continuous fluid dyed to a beige shade. A second includes binder fiber (Inserted Only Control 2 yarn) is not singed, heatset (Suessen® at 200° C.), tufted into a loop carpet construction (32 oz face weight, 5/16″ pile height, ⅛ gauge), then continuous fluid dyed to a beige shade. A third (Singed Only Control 1 yarn) is not inserted with the binder fiber, singed, heatset (Suessen® at 200° C.), tufted into a loop carpet construction (32 oz face weight, 5/16″ pile height, ⅛ gauge), then continuous fluid dyed to a beige shade.

These three carpets are evaluated for carpet aesthetics as described in Test A, then subjected to 60,000 traffics (graded at 20,000 and 60,000 traffic increments) and evaluated for worn surface appearance as described in Test B. Table III presents results from Test A and B. The pair of carpets untrafficked and worn to various levels of traffics are compared by Test A to determine how significant the level of difference in untrafficked carpet aesthetics and by Test B to determine how significant the level of difference in carpet wear trafficked to each of these levels. In each instance, the Inserted/Singed Test Carpet is selected as having significantly better unworn carpet aesthetics and better worn carpet appearance.

TABLE III
Inserted/Singed Test Carpets Ranked Against Singed Only
And Inserted Only Carpets

| | Untrafficked | 20K | 60K |
|---|---|---|---|
| Test A (Untrafficked) | 16/16* | n/a | n/a |
| Test A (Untrafficked) | 16/16** | n/a | n/a |
| Test B (Trafficked) | n/a | 15/16* | 16/16* |
| Test B (Trafficked) | n/a | 15/16** | 16/16** |

*Inserted/Singed (A1 & A2) versus Singed Only Control 1 (B1 & B2)
**Inserted/Singed (A1 & A2) versus Inserted Only Control 2 (C1 & C2)

### EXAMPLE 3

This example illustrates the preparation of carpet fiber/binder insert yarn blends of the invention and the improved worn surface appearance and initial carpet aesthetics characteristics of a commercial cut-pile, saxony carpet made therefrom. Specifically, the benefits of combining singeing with binder fiber insertion are demonstrated both relative to those derived from singeing alone and to those derived from inserting the binder fiber alone. Test carpets are made using conventionally crimped nylon 66 carpet staple fibers which are uniform in appearance and have a length of 7½ inches, a denier of 15, and an average of 10.5 crimps per inch. These fibers are carded and spun into singles yarn; the singles yarn inserted with a 75 denier/12 filament binder fiber (6/66/12) at parallel winding through the Murata® (at speeds of 1200 mpm); then a singles without the binder fiber and a singles with the binder fiber are plied together in a 2-for-1 twisting operation. This plied yarn is made at a 3.75/2 cotton count (cc) and twisted at 5.6Z (singles)×5.1S(ply). One test yarn (Inserted/Singed Test yarn) item is singed (Kuesters®), heatset (Suessen® at 200° C.), tufted into a cut-pile saxony carpet construction (42 oz face weight, 5/16″ pile height, 1/10 gauge), then batch beck dyed to a plum shade. A second test yarn (Singed Only Control 1 Test yarn) is twisted from two singles not containing the binder insert fiber; it is singed (Kuesters®), heatset (Suessen® at 200° C.), tufted into a cut-pile saxony carpet construction (42 oz face weight, 5/16″ pile height, 1/10 gauge), then batch beck dyed to a plum shade. A third contains binder fiber (Inserted Only Control 2 Test yarn) is not singed, heatset (Suessen® at 200° C.), tufted into a cut-pile saxony carpet construction (42 oz face weight, 5/16″ pile height, 1/10 gauge), then batch beck dyed to a plum shade.

These three test carpets are evaluated for carpet aesthetics as described in Test A, then subjected to 50,000 traffics (graded at 20,000 and 50,000 traffics) and evaluated for worn surface appearance as described in Test B. Table IV presents results from Test A and B. The pair of carpets untrafficked and worn to various levels of traffics are compared by Test A to determine how significant the level of difference in untrafficked carpet aesthetics and by Test B to determine how significant the level of difference in carpet wear trafficked to each of these levels. In each instance, the Inserted/Singed Test Carpet is selected as having better unworn carpet aesthetics and better worn carpet appearance.

TABLE IV
Inserted/Singed Test Carpets Ranked Against Singed Only
And Inserted Only Carpets

| | Untrafficked | 20K | 50K | 100K |
|---|---|---|---|---|
| Test A (Untrafficked) | 16/16* | n/a | n/a | n/a |
| Test A (Untrafficked) | 15/16** | n/a | n/a | n/a |
| Test B (Trafficked) | n/a | 15/16* | 16/16* | 15/16* |
| Test B (Trafficked) | n/a | 14/16** | 15/16** | 16/16** |

*Inserted/Singed (A1 & A2) versus Singed Only Control 1 (B1 & B2)
**Inserted/Singed (A1 & A2) versus Inserted Only Control 2 (C1 & C2)

### EXAMPLE 4

This example illustrates the increased productivity achieved at heatsetting by utilizing the binder fiber insertion in combination with singeing. Specifically, the benefits of combining singeing with binder fiber insertion are demonstrated relative to those derived from singeing alone. Test carpets are made using conventionally crimped nylon 66 carpet staple fibers which are uniform in appearance and have a length of 7½ inches, a denier of 15, and an average of 10.5 crimps per inch. These fibers are carded and spun into singles yarn; the singles yarn inserted with a 75 denier/12 filament binder fiber (6/66/12) at parallel winding through the Murata® (at speeds of 1200 mpm); then a singles without the binder fiber and a singles with the binder fiber are plied together in a 2-for-1 twisting operation. This plied yarn is made at a 3.00/2 cotton count (cc) and twisted at 5.OZ (singles)×5.0S(ply). One test yarn (Inserted/Singed Test yarn) item is singed (Kuesters®), heatset (Suessen® at 200° C.) at various dwell times, tufted into a cut-pile saxony carpet construction (45 oz face weight, 5/16″ pile height, 5/32 gauge), then continuous fluid dyed to a beige shade. A second test yarn (Singed Only Control 1 Test yarn) is twisted from two singles not containing the insert yarn; it is singed (Kuesters®), heatset (Suessen® at 200° C.) at various dwell times, tufted into a cut-pile saxony carpet construction (45 oz face weight, 5/16″ pile height, 5/32 gauge), then continuous fluid dyed to a beige shade.

The difference in appearance retention (using a single grader) between the Inserted/Singed and Singed Only Control 1 Test Carpets is determined using Test C. As shown in Table V, the Inserted/Singed Test Carpet retains good wearability as evidenced by its 2.0 ASTM grade when the dwell time is reduced from 60 to 55 to 50 seconds. The Singed Only Control 1 Test Carpet exhibits worse wear and deteriorates as the dwell time is reduced. Note: Test C is used here because the initial, untrafficked appearances were similar for the two Test Carpets.

TABLE V
Decrease of Dwell Times of Inserted/Singed Carpet
Over Singed Only Carpet

| | Dwell Times (sec) | | |
|---|---|---|---|
| | 60 | 55 | 50 |
| Inserted/Singed | 2.0 | 2.0 | 2.0 |
| Test Carpet (ASTM Grade) | | | |
| 20,000 Trafficks | | | |
| Singed Only Control 1 | 4.0 | 4.3 | n/a |
| Test Carpet (ASTM Grade) | | | |
| 20,000 Trafficks | | | |

### EXAMPLE 5

This example illustrates the performance of four different binder fibers in a residential cut-pile, textured carpet construction. Specifically, the relative performance of these binder fibers are demonstrated both relative to one another and to one made without binder fiber. Test carpets are made using conventionally crimped nylon 66 carpet staple fibers which are uniform in appearance and have a length of 7½ inches, a denier of 15, and an average of 10.5 crimps per inch. These fibers are carded and spun into singles yarn; the singles yarn inserted with a 75 denier/12 filament binder fiber (6/66/12, 75d), a 60 denier/20 filament binder fiber (6/66/12, 60d), a 75 denier/13 filament binder fiber (6/69 copolymer), or a 100 denier/20 filament binder fiber (modified PE) at parallel winding through a Murata® (at speeds of 1200 mpm); then a singles without the insert and a singles with the insert are plied together in a 2-for-1 twisting operation. Each plied yarn is made at a 3.50/2 cotton count (cc) and twisted at 5.0Z (singles)×5.0S(ply). One of each of the inserted test yarns is passed through a stuffer box then heatset (Suessen® at 200° C.), tufted into a cut-pile textured carpet construction (45 oz face weight, 9/16″ pile height, 5/32 gauge), then continuous fluid dyed to a beige shade.

A second test yarn (Control Test yarn) is twisted from two singles not containing a binder fiber; it is passed through a stuffer box, heatset (Suessen® at 200° C.), tufted into a cut-pile textured carpet construction (45 oz face weight, 9/16″ pile height, 5/32 gauge), then continuous fluid dyed to a beige shade.

The difference in appearance retention (using a single grader) among the four binder fibers and the Control Test yarn is determined using Test C. As shown in Table VI, all four binder fibers produced carpets that performed better than did the uninserted control carpet; further, the polyamide 6/69 copolymer performed better as a binder fiber than did the polyamide 6/66/12 terpolymer which has been used as the preferred binder fiber in Examples I through V. Note: Since carpets made from each of these binder fibers had similar initial appearances, Test C provided a meaningful assessment of growing differences in worn appearance.

TABLE VI
Inserted Test Carpets Made with Three Different Binder
Fibers Ranked Against One Another and a Test Carpet
Made Without Binder Yarn

| | 20K Appearance |
|---|---|
| Binder Fiber | Retention Ranks |
| 6/66/12, 75d | 3.3 |
| 6/66/12, 60d | 4.0 |
| 6/69 Copolymer | 3.0 |
| Modified PE | 4.0 |
| Control Test Yarn | 4.5 |

As is readily apparent from these examples, the carpet fiber yarn of the present invention (i.e., having binder fiber and being singed) provides carpet having unexpectedly improved initial appearance and trafficked surface properties than carpets having conventional yarn (i.e., either unsinged yarn with binder fiber or singed yarn without binder fiber).

All of the compositions, products and methods disclosed and claimed herein may be produced and performed without undue experimentation in light of the present disclosure. While the compositions and methods of this invention have been described in terms of preferred embodiments, it will be apparent to those of skill in the art that variations may be applied to the compositions, products and methods and in the steps, or in the sequence of steps, of the methods described herein without departing from the concept, spirit and scope of the invention. More specifically, it will be apparent that certain agents that are chemically related may be substituted for the agents described herein while the same or similar results will be achieved. All such similar substitutes and modifications apparent to those skilled in the art are deemed to be within the scope, spirit and concept of the invention as defined by the appended claims.

What is claimed is:

1. A carpet fiber yarn comprising,
carpet fiber and binder fiber, said yarn being subjected to singeing to remove protruding fiber ends, and subjected to heat sufficient to melt said binder fiber, wherein the initial appearance of a first test carpet having a pile comprised of said yarn is improved, as determined by Test A, than with a corresponding second test carpet having a pile comprised of an unsinged yarn with said carpet fiber and said binder fiber, said unsinged yarn also being subjected to heat sufficient to melt said binder fiber.

2. A yarn according to claim 1, wherein said carpet fiber comprises polyamide, polyester, polypropylene, acrylic, or blends thereof.

3. A yarn according to claim 1, wherein said carpet fiber comprises nylon 6,6.

4. A yarn according to claim 1, wherein said binder material comprises copolyamides, functionalized polyolefins, polyurethanes, polyesters, or blends thereof.

5. A yarn according to claim 1, wherein said binder material comprises nylon 6/66/12 terpolymers, nylon 6/66/69 terpolymers, nylon 6/69 copolymers, or blends thereof.

6. A yarn according to claim 1, wherein said binder material comprises staple fiber, monofilament fiber, multicomponent fiber, coated fiber, or combinations thereof.

7. A yarn according to claim 1, wherein said binder fiber comprises monofilament fiber.

8. A yarn according to claim 1, wherein the difference in said initial appearance between said first and second carpets is predictable at least about at the 90% level of significance, as determined by Test A.

9. A yarn according to claim 1, wherein the difference in said initial appearance between said first and second carpets is predictable at least about at the 95% level of significance, as determined by Test A.

10. A yarn according to claim 1, wherein the number of correct segregations as determined by Test A is at least 10 out of 16 assessments.

11. A yarn according to claim 1, wherein the number of correct segregations as determined by Test A is at least 12 out of 16 assessments.

12. A yarn according to claim 1, wherein the number of correct segregations as determined by Test A is at least 14 out of 16 assessments.

13. A yarn according to claim 1, wherein said yarn is a staple fiber yarn or a BCF yarn.

14. A carpet comprising the yarn of claim 1.

15. A carpet fiber yarn comprising,
carpet fiber and binder fiber, said yarn being subjected to singeing to remove protruding fiber ends, and subjected to heat sufficient to melt said binder fiber, wherein trafficked appearance of a first test carpet having a pile comprised of said yarn is improved, as determined by Test B, then with a corresponding second test carpet having a pile comprised of an unsinged yarn with said carpet fiber and said binder fiber, said unsinged yarn also being subjected to heat sufficient to melt said binder fiber.

16. A yarn according to claim 15, wherein said carpet fiber comprises polyamide, polyester, polypropylene, acrylic, or blends thereof.

17. A yarn according to claim 15, wherein said carpet fiber comprises nylon 6,6.

18. A yarn according to claim 15, wherein said binder fiber comprises copolyamides, functionalized polyolefins, polyurethanes, polyesters, or blends thereof.

19. A yarn according to claim 15, wherein said binder fiber comprises nylon 6/66/12 terpolymers, nylon 6/66/69 terpolymers, nylon 6/69 copolymers, or blends thereof.

20. A yarn according to claim 15, wherein said binder fiber comprises staple fiber, monofilament fiber, multicomponent fiber, or combinations thereof.

21. A yarn according to claim 15, wherein said binder fiber comprises monofilament fiber.

22. A yarn according to claim 15, wherein the difference in said initial appearance between said first and second carpets is predictable at least about at the 90% level of significance, as determined by Test B.

23. A yarn according to claim 15, wherein the difference in said initial appearance between said first and second carpets is predictable at least about at the 95% level of significance, as determined by Test B.

24. A yarn according to claim 15, wherein the number of correct segregations as determined by Test B is at least 10 out of 16 assessments.

25. A yarn according to claim 15, wherein the number of correct segregations as determined by Test B is at least 12 out of 16 assessments.

26. A yarn according to claim 15, wherein the number of correct segregations as determined by Test B is at least 14 out of 16 assessments.

27. A yarn according to claim 15, wherein said yarn is a staple fiber yarn or a BCF yarn.

28. A carpet comprising the yarn of claim 15.

29. A method for producing a carpet yarn comprising,
forming a singles yarn comprising carpet fiber;
forming a ply-twisted yarn comprising said singles yarn and binder fiber;
singeing said ply-twisted yarn to remove protruding fiber ends;
and heating said ply-twisted yarn in order to melt said binder fiber.

30. A method according to claim 29, wherein said binder fiber is parallel wound with said singles yarn prior to forming said ply-twisted yarn.

31. A method according to claim 29, wherein said binder fiber is parallel wound with said singles yarn onto a package, and thereafter ply-twisted with another of said singles yarn to form said ply-twisted yarn.

32. A method according to claim 29, wherein said binder fiber is directly ply-twisted with at least one of said singles yarn.

33. A method according to claim 29, wherein said binder fiber is directly inserted with said singles yarn into an auto winder and thereafter ply-twisted with another of said singles yarn to form said ply-twisted yarn.
